(19) United States
(12) Patent Application Publication
(10) Pub. No.: US 2016/0135114 A1
(43) Pub. Date: May 12, 2016

(54) THROTTLING PACKET-SWITCHED CALL ESTABLISHMENT IN WIRELESS COMMUNICATIONS

(71) Applicant: QUALCOMM Incorporated, San Diego, CA (US)

(72) Inventors: Liangchi HSU, San Diego, CA (US); Thawatt GOPAL, San Diego, CA (US); Huan XU, San Diego, CA (US); Ansah Ahmed SHEIK, Hyderabad (IN); Satish Pavan Kumar NICHANAMETLA, Hyderabad (IN); Vagish GUPTA, Hyderabad (IN); Sathish KRISHNAMOORTHY, Hyderabad (IN); Sitaramanjaneyulu KANAMARLAPUDI, San Diego, CA (US); Qingxin CHEN, Del Mar, CA (US); Xuepan GUAN, Beijing (CN); Xiaojian LONG, Beijing (CN)

(21) Appl. No.: 14/705,611

(22) Filed: May 6, 2015

Related U.S. Application Data
(60) Provisional application No. 62/078,617, filed on Nov. 12, 2014.

(51) Int. Cl. H04W 48/06; H04W 24/08

(52) U.S. Cl. CPC H04W 48/06; H04W 24/08; H04W 84/042

(57) ABSTRACT

Aspects described herein relate to throttling packet-switched (PS) call establishment in wireless communications. A circuit-switched (CS) call can be conducted by using a first radio access technology (RAT). A cell update (CU) procedure for a PS call using a second RAT can be detected as due to one or more conditions. A cause for the one or more conditions can be determined based on one or more parameters related to a transmitter or receiver. PS call establishment attempts can accordingly be throttled based at least in part on determining the cause for the one or more conditions

### CLAIM OF PRIORITY UNDER 35 U.S.C. §119

The present Application for Patent claims priority to Provisional Application No. 62/078,617 entitled “THROTTLING PACKET-SWITCHED CALL ESTABLISHMENT IN WIRELESS COMMUNICATIONS” filed Nov. 12, 2014, which is assigned to the assignee hereof and hereby expressly incorporated by reference herein.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Some wireless devices support the ability to concurrently communicate with multiple wireless networks that utilize different wireless network technologies by utilizing multiple device subscriptions. Such devices may employ multiple subscriber identity modules (SIM) that each support a device subscription. In this example, a wireless device that supports multiple subscriptions can concurrently operate a circuit-switched call over a legacy wireless network using one subscription (e.g., global system for mobile communication (GSM)) while operating a packet-switched call using another subscription (e.g., UMTS/LTE). These communications may share a single transmit/receive chain at the wireless device. Thus, where the packet-switched call fails, frequent attempts to reestablish the packet-switched call may inhibit an on-going circuit-switched call.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for throttling packet-switched (PS) call establishment in wireless communications is provided. The method includes conducting a circuit-switched (CS) call using a first radio access technology (RAT), detecting a cell update (CU) procedure for a PS call using a second RAT due to one or more conditions, determining a cause for the one or more conditions based on one or more parameters related to a transmitter or receiver, and throttling PS call establishment attempts based at least in part on determining the cause for the one or more conditions.

In another example, an apparatus for throttling PS call establishment in wireless communications is provided. The apparatus includes a transceiver configured to conduct a CS call using a first RAT, and one or more processors configured to execute a condition detecting function configured to detect a CU procedure for a PS call using a second RAT due to one or more conditions, and determine a cause for the one or more conditions based on one or more parameters related to a transmitter or receiver, and a PS call establishing function configured to throttle PS call establishment attempts based at least in part on determining the cause for the one or more conditions.

In another example, a computer-readable storage medium comprising computer-executable code for throttling packet-switched (PS) call establishment in wireless communications is provided. The code includes code for conducting a CS call using a first RAT, code for detecting a CU procedure for a PS call using a second RAT due to one or more conditions, code for determining a cause for the one or more conditions based on one or more parameters related to a transmitter or receiver, and code for throttling PS call establishment attempts based at least in part on determining the cause for the one or more conditions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless communications system according to aspects described herein;

FIG. 2 is a flow diagram comprising a plurality of functional blocks representing an example methodology aspects described herein;

FIG. 3 is a flow diagram comprising a plurality of functional blocks representing an example methodology aspects described herein;

FIG. 4 is a diagram illustrating an example communication timeline in accordance with aspects described herein; and

FIG. 5 is a diagram illustrating an example communication timeline in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known functions and/or components are shown in block diagram form in order to avoid obscuring such concepts. In an aspect, the term “function” as used herein may be one of the parts that make up a system, may be hardware, firmware, and/or software, and may be divided into other functions.

Described herein are various aspects related to throttling attempts to establish a packet-switched (PS) call following a cell update procedure, where the cell update procedure may be triggered for a radio link failure (RLF), unrecoverable radio link control (RLC) error (URE), or similar out-of-service (OOS) conditions. Throttling subsequent attempts to establish a PS call following such conditions can mitigate potential impact of the attempts to an on-going circuit-switched (CS) call. For example, a user equipment (UE) may determine whether the cell update is triggered due to RLF/URE/OOS based on transmitter/receiver parameters at the UE, which may relate to sharing of transmission resources between multiple subscriptions at the UE (e.g., a subscription related to the CS call and a subscription related to the PS call). If so, the UE can initialize one or more timers to throttle PS call establishment attempts or related procedures (e.g., cell update requests) such to lessen the impact of PS call establishment attempts on the on-going CS call. For example, a PS throttling timer (TPST) can be initialized to buffer any PS call establishment attempts following a successful cell update (CU) procedure such that PS domain registration can occur, but PS call establishment is delayed in case the RLF/URE/OOS condition still exists. In addition, different CU spacing timers can be initialized for determining when to perform different CU procedures such to, for example, further delay at least an initial CU procedure as compared to subsequent CU procedures to allow additional time for recovering from the RLF/URE/OOS condition.

As used herein, the term “RLF” can refer to a detected condition in a radio link (e.g., at a physical (PHY) layer) that may indicate the radio link is down. For example, RLF may be detected where a received signal strength indicator (RSSI), signal-to-noise ratio (SNR) or other measurement of a signal over the radio link is less than a threshold, where certain communications are not received (e.g., feedback for previously transmitted communications), where a channel cannot be properly decoded over one or more signals, etc. RLF can be defined as a condition or set of conditions detected specific to a RAT (e.g., RLF as defined in UMTS specifications).

In addition, as used herein, the term “URE” can refer to one or more (e.g., a sequence of) detected occurrences over a connection that may indicate failure at an RLC layer. For example, URE may be detected where one or more retransmissions of one or more signals are negatively-acknowledged (e.g., consecutively and/or within a period of time), where a reset of the RLC layer fails (e.g., a number of reset packet data units (PDU) are transmitted consecutively and/or within a period of time), etc. URE can be defined as a condition or set of conditions detected specific to a RAT (e.g., URE as defined in UMTS specifications).

Moreover, as used herein, the term “CU procedure” can relate to performing update of a serving cell for a UE based on one or more detected conditions. For example, the CU procedure may include transitioning a UE to a certain state (e.g., a cell forward access channel (CELL_FACH) state) to update the serving cell, and may involve a cell reselection procedure. A CU procedure can be defined as a condition or set of conditions detected specific to a RAT (e.g., CU as defined in UMTS specifications).

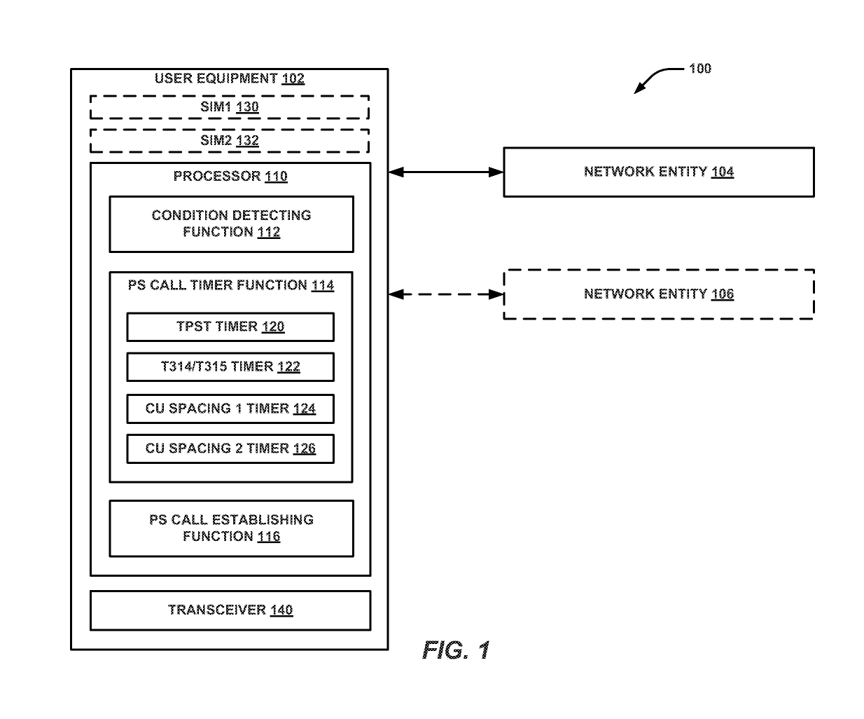

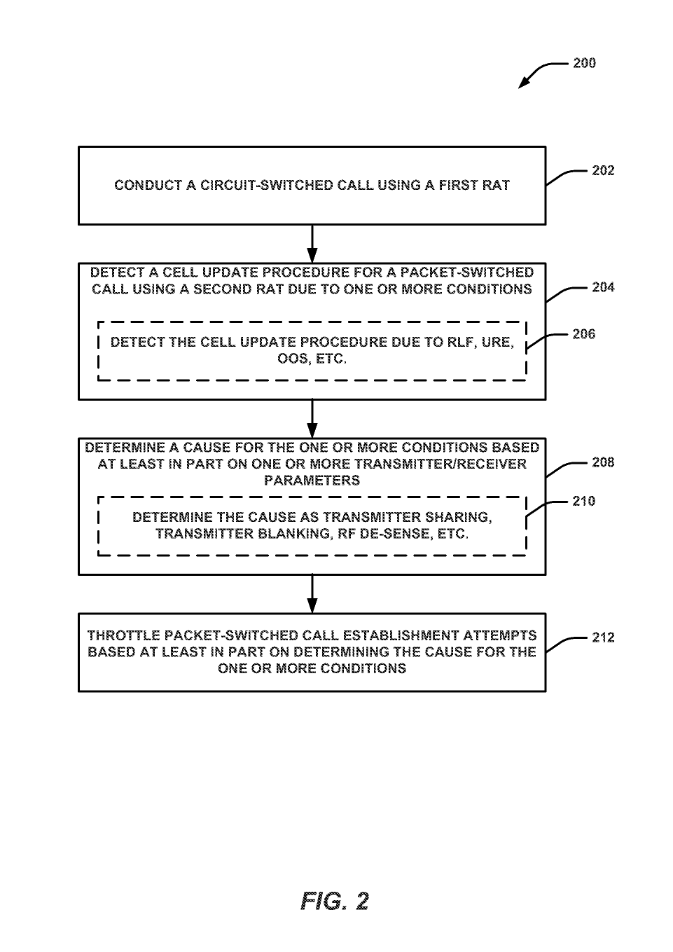

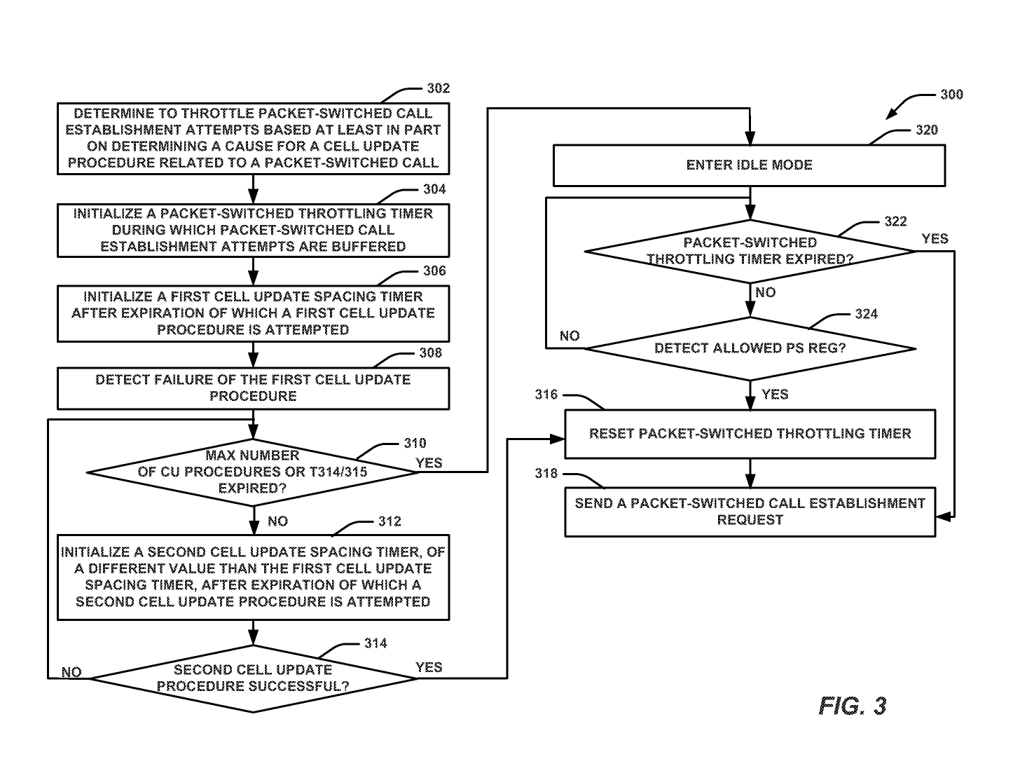

Referring to FIGS. 1-3, aspects are depicted with reference to one or more functions and one or more methods that may perform the actions or functions described herein. Although the operations described below in FIGS. 2-3 are presented in a particular order and/or as being performed by an example function, it should be understood that the ordering of the actions and the functions performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

FIG. 1 is a schematic diagram illustrating a system 100 for wireless communication, according to an example configuration. System 100 includes a user equipment (UE) 102 that communicates with one or more network entities 104, 106 over one or more subscriptions in one or more wireless networks. It is to be appreciated that UE 102 can communicate with a network entity 104 and/or with another network entity 106 using different device subscriptions. In this regard, UE 102 may be a multi-subscription UE that optionally includes a subscriber identity module (SIM) for each device subscription, and can utilize a first SIM (e.g., SIM1 130) in communicating with network entity 104 over a first subscription and a second SIM (e.g., SIM2 132) in communicating with network entity 104 or 106 over a second subscription, though the UE 102 may use similar radio resources in communicating using the multiple subscriptions. It is to be appreciated, however, that UE 102 may more generally establish communications with multiple network entities using subscription information stored in a memory of the UE 102 (e.g., an internal memory, an external memory such as a memory card, etc.). In an example, UE 102 may establish a CS call with network entity 104 and a PS call with network entity 106 by communicating therewith over a transceiver 140. In another example, UE 102 may establish a CS call and PS call with network entity 104. Network entities 104 and 106 may be different Node Bs, different cells of the same Node B, etc.

According to an example, UE 102 includes a processor 110, which may include one or more processors, for performing various functions described herein for establishing and managing the CS call with network entity 104 and the PS call with network entity 104 or 106. Processor 110 can include condition detecting function 112 for detecting one or more conditions that may cause a CU in the PS call (e.g., based on detecting a CU request sent by UE 102), a PS call timer function 114 for initializing one or more timers associated with throttling PS call establishment attempts, and a PS call establishing function 116 for attempting to establish a PS call subject to the one or more timers. PS call timer function 114 can manage various timers to throttle the PS call establishment attempts, such as a TPST timer 120 for delaying PS call establishment attempts, a T314/T315 timer 122 for delaying release of radio resources for the CS call and PS call, respectively, following the one or more conditions, a CU spacing 1 timer 124 for delaying an initial CU procedure, and a CU spacing 2 timer 126 for delaying one or more CU procedures subsequent to the initial CU procedure. Processor 110 may also include a PS call establishing function 116 for establishing a PS call with network entity 104 and/or 106 at least in part by communicating therewith via transceiver 140. The transceiver 140 may be operable for communicating with various other apparatuses over a wireless transmission medium using configured radio frequency (RF) resources. For example, transceiver 140 may include a transmitter, receiver, related transmit/receive processors, etc.

UE 102 may comprise any type of mobile device, such as, but not limited to, a smartphone, cellular telephone, mobile phone, laptop computer, tablet computer, or other portable networked device that can be a standalone device, tethered to another device (e.g., a modem connected to a computer), a watch, a personal digital assistant, a personal monitoring device, a machine monitoring device, a machine to machine communication device, etc. In addition, UE 102 may also be referred to by those skilled in the art as a mobile station, a subscriber station, a mobile unit, a subscriber unit, a wireless unit, a remote unit, a mobile device, a mobile communications device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, UE 102 may be small and light enough to be considered portable and may be configured to communicate wirelessly via an over-the-air (OTA) communication link using one or more OTA communication protocols described herein. Additionally, in some examples, UE 102 may be configured to facilitate communication on multiple separate networks via multiple separate subscriptions, multiple radio links, and/or the like.

Furthermore, network entity 104 may comprise one or more of any type of network module, such as an access point, a macro cell, including a base station (BS), node B, eNodeB (eNB), a relay, a peer-to-peer device, an authentication, authorization and accounting (AAA) server, a mobile switching center (MSC), a mobility management entity (MME), a radio network controller (RNC), a small cell, etc. As used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a BS, an access point, a femto node, a femtocell, a pico node, a micro node, a Node B, eNB, home Node B (HNB) or home evolved Node B (HeNB). Therefore, the term “small cell,” as used herein, refers to a relatively low transmit power and/or a relatively small coverage area cell as compared to a macro cell. Additionally, network entity 104 may communicate with one another and/or with one or more other network entities of wireless and/or core networks

Additionally, system 100 may include any network type, such as, but not limited to, wide-area networks (WAN), wireless networks (e.g. 802.11 or cellular network, such as Global System for Mobile Communications (GSM) or its derivatives, etc.), the Public Switched Telephone Network (PSTN) network, ad hoc networks, personal area networks (e.g. Bluetooth®) or other combinations or permutations of network protocols and network types. Such network(s) may include a single local area network (LAN) or wide-area network (WAN), or combinations of LANs or WANs, such as the Internet. Such networks may comprise a Wideband Code Division Multiple Access (W-CDMA) system, and may communicate with one or more UEs 102 according to this standard. As those skilled in the art will readily appreciate, various aspects described herein may be extended to other telecommunication systems, network architectures and communication standards. By way of example, various aspects may be extended to other Universal Mobile Telecommunications System (UMTS) systems such as Time Division Synchronous Code Division Multiple Access (TD-SCDMA), High Speed Downlink Packet Access (HSDPA), High Speed Uplink Packet Access (HSUPA), High Speed Packet Access Plus (HSPA+) and Time-Division CDMA (TD-CDMA). Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), Institute of Electrical and Electronics Engineers (IEEE) 802.11 (Wi-Fi), IEEE 802.16 (WiMAX®), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., UEs 102, network entity 104) may be coupled to a core network via one or more wired or wireless connections.

FIG. 2 illustrates a method 200 for throttling PS call establishment in multi-subscription devices to mitigate the impact of PS call establishment attempts on an on-going CS call. Method 200 includes, at Block 202, conducting a CS call using a first radio access technology (RAT). Transceiver 140 (FIG. 1) can establish and conduct the CS call (e.g., with network entity 104) using the first RAT. For example, transceiver 140 may establish the CS call over a legacy network, such as global system for mobile communication (GSM) or similar networks, such that UE 102 is in active communications with the network entity 104 transmitting data to and receiving data from a wireless network via network entity 104. Transceiver 140 may establish the CS call based at least in part on instructions from the processor 110.

Method 200 also includes, at Block 204, detecting a CU procedure for a PS call using a second RAT due to one or more conditions. Condition detecting function 112 can detect the CU procedure for the PS call using the second RAT due to the one or more conditions. Detecting the cell update procedure at Block 204 may optionally include, at Block 206, detecting the cell update procedure due to RLF, URE, OOS, etc. For example, condition detecting function 112 can detect the CU procedure occurring during a PS call with network entity 104 or 106, or during establishment thereof In an example, condition detecting function 112 detects the CU procedure being initiated by the UE 102 and can determine that the CU relates to the one or more conditions based on a cause code in the CU procedure or other parameter observed of the PS communications with network entity 104 or 106. For example, a cause code in the CU procedure or a message of the CU procedure may indicate RLF, URE, OOS, etc. The PS call can relate to WCDMA or another RAT, for example, that supports packet-based services and allows PS calls to be established.

Method 200 can also include, at Block 208, determining a cause for the one or more conditions based at least in part on one or more transmitter/receiver parameters. Condition detecting function 112 can also determine the cause for the one or more conditions (e.g., the RLF, URE, OOS, etc.) based at least in part on the one or more transmitter/receiver parameters. For example, determining the cause at Block 208 may optionally include, at Block 210, determining the cause as transmitter sharing, transmitter blanking, RF de-sense, etc. For example, condition detecting function 112 can evaluate transmitter/receiver statistics (e.g., of signals transmitted or received by transceiver 140) over a past number of time instances (e.g., a number of slots) to determine whether the one or more conditions were caused by any of single transmitter sharing, transmitter blanking, or radio frequency (RF) de-sense provided by common functional entities shared between the CS and PS call (e.g., a transmitter and/or receiver chain or other resources of transceiver 140).

For example, single transmitter sharing can relate to multiple subscriptions (e.g., a subscription for the CS with network entity 104 and a subscription for the PS call with network entity 106) sharing transmitter resources of the UE 102. In this example, RLF/URE/OOS caused by single transmitter sharing can relate to transmission resources of transceiver 140 tuned to transmit for the CS call when the PS call is expected to transmit, for example. Transmitter blanking and RF de-sense can refer to the UE 102 receiving RF interference from its own transmitter (e.g., receiving interference at a receiver of the UE 102 caused by signals transmitted by the UE 102). In this example, RLF/URE/OOS caused by transmitter blanking can relate to transceiver 140 transmitting for the CS call and receiving the transmission over resources for receiving PS call communications such that the CS call transmissions may interfere with or otherwise prevent receiving of the communications related to the PS call by transceiver 140. In any case, condition detecting function 112 can detect the one or more conditions based on evaluating one or more parameters of the transmitter/receiver chains or other RF resources of the transceiver 140.

In one specific example, condition detecting function 112 can detect a cell update procedure due to RLF/URE/OOS based on determining that a difference in transmitter sharing between multiple subscriptions in a period of time (e.g., a number of slots) achieves one or more thresholds or differs from typical (e.g., average) transmitter sharing observed over one or more previous periods of time. For example, given a number of slots, transmitter sharing among multiple subscriptions may be expected to achieve a configured or observed ratio (e.g., around 1/n of the transmitter resources to each of n subscriptions). Condition detecting function 112 can detect a deviation from the ratio in comparing transmitter usage (e.g., of SIM1 130 and SIM2 132) that may indicate transmitter sharing is favoring one or more of the subscriptions, which may indicate unfavorable radio conditions for the other subscription(s), and thus that transmitter sharing is likely the cause for RLF/URE/OOS. Condition detecting function 112 may additionally or alternatively detect whether transmitter blanking/RF de-sensing are the cause based at least in part on whether transmissions for the PS call are blanked (e.g., for receiving transmission of the CS call) or the RF is otherwise de-sensed in receiving transmissions for the CS call in a threshold portion of a period of time (e.g., a number of slots).

Method 200 also includes, at Block 212, throttling PS call establishment attempts based at least in part on determining the cause for the one or more conditions. PS call establishing function 116 can throttle the PS call establishment attempts based at least in part on determining the cause for the one or more conditions. For example, PS call timer function 114 can initialize one or more timers based on determining the cause for the one or more conditions that resulted in the CU procedure, as described further herein, and PS call establishing function 116 can determine whether to buffer PS call establishment attempts or related procedures (e.g., PS domain establishment procedures, such as a CU procedure) based on whether the one or more timers have expired.

FIG. 3 illustrates an example method 300 for throttling PS call establishment attempts based on initializing one or more timers following cell update caused by one or more detected conditions during a PS call. Method 300 includes, at Block 302, determining to throttle PS call establishment attempts based at least in part on determining a cause for a CU procedure related to the PS call. PS call establishing function 116 can determine to throttle the PS call establishment attempts based at least in part on determining the cause for the CU procedure related to the PS call. For example, as described in reference to FIGS. 1 and 2 above, condition detecting function 112 can determine the cause for the CU procedure (e.g., a cause related to one or more conditions resulting in the CU procedure). Thus, in a specific example, condition detecting function 112 can detect RLF/URE/OSS based on transmitter sharing, transmitter blanking, RF de-sense, etc. PS call establishing function 116 can accordingly determine to throttle PS call establishment based on the conditions and/or related causes. Thus, PS call timer function 114 can initialize the one or more timers based on the RLF/URE/OOS of the PS call, a detected cause thereof, etc. As described, determining to throttle the PS call in this regard may be based on determining that the RLF/URE/OOS is caused by any of single transmitter sharing, transmitter blanking, or RF de-sense detected based on transmitter/receiver parameters of transceiver 140, as described above.

Method 300 includes, at Block 304, initializing a PS throttling timer (TPST) during which PS call establishment attempts are buffered. PS call timer function 114 can initialize the TPST timer 120 during which PS call establishing function 116 buffers PS call establishment attempts so that the attempts are not transmitted to network entity 104 or 106. In an example, initializing the TPST may be based on determining to throttle PS call establishment (e.g., based on determining the cause for the cell update procedure). In addition, based at least in part on the cell update procedure, PS call timer function 114 can initialize a T314/T315 timer 122 after which radio resources of the transceiver 140 may be released if a PS call is not established, and the transceiver 140 may switch to idle mode communications over the subscription related to the PS call. It is to be appreciated that PS call establishing function 116 may buffer PS call establishment requests (e.g., received from non-access stratum (NAS) or other upper layers) while the TPST timer 120 is running. In some examples, PS call establishing function 116 may also buffer NAS PS registration requests when the T314/T315 timer 122 is running, but may allow the NAS PS registration requests when the UE is in idle mode to improve PS call experience at the UE 102. Moreover, for example, PS call timer function 114 may initialize the TPST timer 120 to a value that is greater than or equal to a value of T314/T315 timer 122, which may be relative to the T314/T315 timer 122, may be a fixed value, etc.

Method 300 also includes, at Block 306, initializing a first CU spacing timer after expiration of which a first CU procedure is attempted. PS call timer function 114 can initialize the CU spacing 1 timer 124 after expiration of which the first CU procedure can be attempted with network entity 104 or 106. In an example, initializing the first CU spacing timer may be based on determining to throttle PS call establishment as well (e.g., based on determining the cause for the cell update procedure). In one example, PS call timer function 114 can initialize the CU spacing 1 timer 124 based on a timer related to determining whether a CU procedure is successfully performed (e.g., a CU confirm message is received while the timer is running), such as a T302 timer. For example, the CU spacing 1 timer 124 may be initialized to be greater than the T302 timer. For example, based on detecting expiration of the CU spacing 1 timer 124, transceiver 140 can attempt the first CU procedure with network entity 104 or 106 relating to the PS call (e.g., based on related instructions from the PS call establishing function 116). CU spacing 1 timer 124 can be greater than a second CU spacing timer, CU spacing 2 timer 126, for subsequent CU procedures to increase the likelihood of success of the initial CU procedure (e.g., due to allowing more time for the one or more conditions that caused the CU procedure to resolve). In this example, however, method 300 includes, at Block 308, detecting failure of the first cell update procedure. PS call establishing function 116 can detect failure of the first cell update procedure, which may be based on the one or more conditions that caused the CU procedure (e.g., RLF/URE/OOS or causes thereof, such as transmitter sharing, transmitter blanking, RF de-sense, etc.).

Method 300 includes, at Block 310, determining whether either a maximum number of CU procedures have occurred or whether a T314/T315 timer has expired. PS call timer function 114 can determine whether either the maximum number of CU procedures has occurred or whether the T314/T315 timer 122 has expired. As described, for example, the T314/T315 timer 122 may have been initialized based on the first CU procedure and/or detecting the condition that caused the first CU procedure.

If the maximum number of CU procedures has not been performed and/or the T314/T315 timer has not expired, method 300 includes, at Block 312, initializing a second CU spacing timer, of a different value than the first CU spacing timer, after expiration of which a second CU procedure is attempted. As described, PS call timer function 114 can initialize the CU spacing 2 timer 126, which can have a different value than the CU spacing 1 timer 124, after expiration of which transceiver 140 can attempt a second CU procedure (e.g., based on instructions from the PS call establishing function 116). For example, the CU spacing 2 timer 126 can be initialized to a value greater than a T302 timer as well. It is to be appreciated, as described further herein, that the CU spacing 1 timer 124 and CU spacing 2 timer 126 may be adjusted or otherwise optimized based on one or more parameters, such as CS voice call quality and sustainability, PS call impact due to single TX sharing, TX blanking, RF de-sense, etc., and/or the like. In one example, the one or more parameters may be determined based on feedback related to previous CS/PS calls and/or related failed CU procedures during the CS/PS calls. For example, the one or more parameters may include a reported or determined CS voice call quality or sustainability in a previous CU procedure for a concurrent PS call, a reported or determined PS call quality, etc.

In any case, based on PS call timer function 114 detecting expiration of the CU spacing 2 timer 126, transceiver 140 attempts the second CU procedure to recover from the one or more conditions that caused the CU procedure. Method 300 also includes, at Block 314, determining whether the second CU procedure is successful. PS call establishing function 116 can determine whether the second CU procedure is successful by transceiver 140. If not, method 300 can proceed back to Block 310 to determine whether the maximum number of CU procedures have been performed or whether the T314/T315 timer has expired, and if not may initialize the second CU spacing timer and attempt a CU procedure following expiration thereof (e.g., via transceiver 140). The maximum number of CU procedures, in an example, may be configured or otherwise specified in a configuration (e.g., N302 number of times total for the first CU procedure and second CU procedure(s) in 3GPP).

If the second CU procedure is successful at Block 314, then method 300 includes, at Block 316, resetting the packet-switched throttling timer. PS call timer function 114 can reset the packet-switched throttling timer based on the success of the second CU procedure. Method 300 also includes, at Block 318, sending a packet-switched call establishment request. PS call establishing function 116 can send the packet-switched call establishment request (e.g., to network entity 104 and/or 106), which may be based on the success of the second CU procedure.

If either the maximum number of CU procedures are performed and/or the T314/T315 timer has expired at Block 310, method 300 includes, at Block 320, entering idle mode. Transceiver 140 can enter the idle mode, as described herein, after the maximum number of CU procedures are performed and/or the T314/T315 timer has expired to avoid further using resources of the transceiver 140 in attempting to perform the CU procedure using the second subscription (e.g., SIM2 132).

Method 300 may also include, at Block 322, determining whether the packet-switched throttling timer (TPST) has expired. PS call establishing function 116 can determine whether the TPST timer 120 has expired. If not, method 300 includes, at Block 324, determining whether an allowed PS registration request is detected. PS call establishing function 116 can determine whether the allowed PS registration request is detected at the transceiver 140. For example, UE 102 may be allowed to perform PS registration requests in idle mode to attempt to register with a PS domain. If such PS registration is successful, the packet switched throttling timer can be reset, at Block 316, and a packet-switched call establishment request can be sent, at Block 318, as described above. If, however, an allowed PS registration is not detected at Block 324, method 300 can proceed to Block 322 to continue to determine whether the packet-switched throttling timer has expired.

If the packet-switched throttling timer is determined to expire, at Block 322, a packet-switched call establishment request can be sent, at Block 318, as described above. Thus, the packet-switched call establishment requests are effectively throttled in this regard to prevent using transmitter resources for the packet-switched services when it may be that the condition causing the CU procedure is not rectified. In any case, using the various timers, UE 102 can lessen the usage of communication resources for PS call establishment based on the TPST timer 120 or T314/T315 timers to avoid significant impact to the on-going CS call. In addition, using the separate CU spacing timers, as described, allows for performing CU at different times such to delay an initial CU procedure allowing the UE 102 more time to recover from conditions that may have caused the CU procedure (e.g., RLF/URE/OOS) and/or causes thereof (such as single transmitter sharing, transmitter blanking, or radio frequency (RF) de-sense, etc.).

It is to be appreciated, for example, that PS call timer function 114 can set and/or adjust the various timers based at least in part on a received configuration and/or using feedback-based mechanisms. For example, PS call timer function 114 may receive feedback regarding a number of successful PS call establishments based on given values for one or more of the timers, and may accordingly adjust the one or more of the timers based at least in part on the number of successful PS call establishments. In another example, PS call timer function 114 may also set and/or adjust timers based on the one or more conditions (e.g., RLF/URE/OOS) and/or a cause thereof (e.g., PS call timer function 114 can use different timer values where the cause is single transmitter sharing, than where the cause is transmitter blanking, and/or radio frequency (RF) de-sense conditions, etc.). In an example, the CU spacing 1 timer 124 and CU spacing 2 timer 126 can be tuned and/or optimized based on the CS call quality and sustainability (e.g., for one or more CS calls during one or more previous CU procedures for one or more concurrent PS calls), PS call impact due to single transmitter sharing, transmitter blanking, and/or radio frequency (RF) de-sense conditions, etc. (e.g., during one or more previous CU procedures for one or more concurrent PS calls). Moreover, for example, PS call timer function 114 may set CU spacing 1 timer 124 as a maximum of the T314 or T315 timer 122 to throttle the first CU attempt under certain conditions (e.g., when the CS voice call quality may suffer from any transmitter activity for the PS call, such as when the CS call radio quality is below a threshold). In other examples, PS call timer function 114 may set CU spacing 1 timer 124 and CU spacing 2 timer 126 such to be within the maximum T314 or T315 timer 122 so that temporary impact from CU processes due to transmitter sharing may be minimized, but CU processes may occur before UE 102 moves to an idle mode.

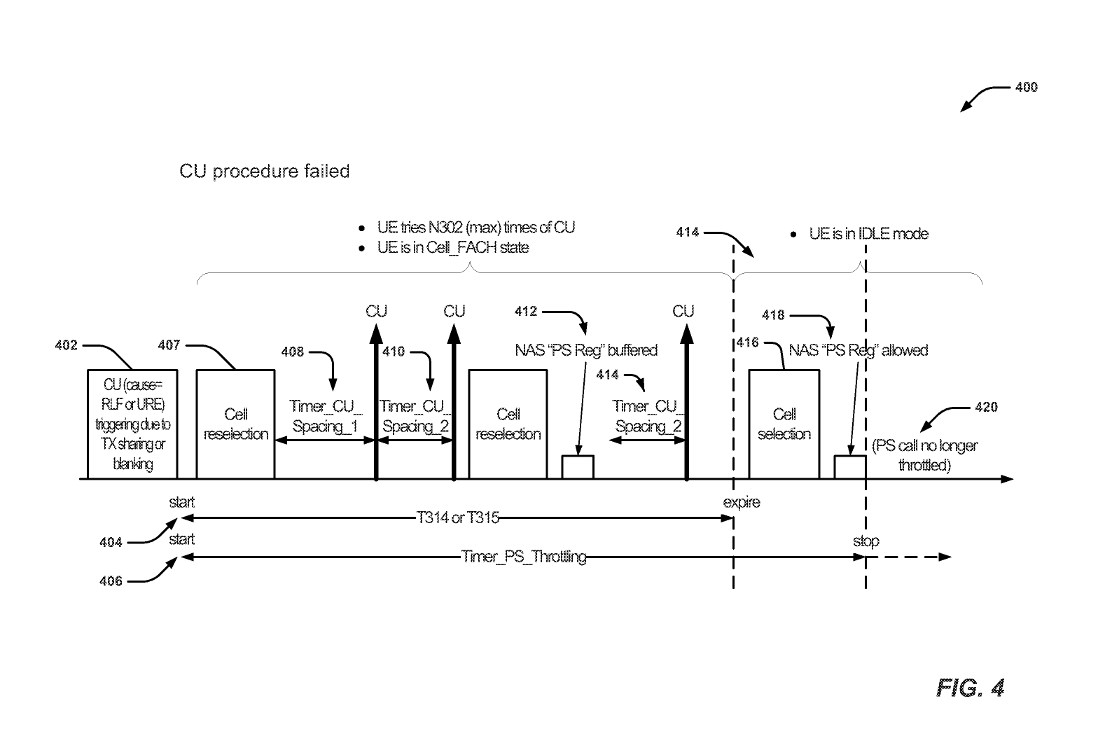

FIG. 4 depicts an example timeline 400 for wireless communications of a multi-subscription UE in accordance with aspects described herein. At the outset, it can be assumed that a CS call is on-going, though not shown, such as a second generation (2G) call, and a third generation (3G)/fourth generation (4G) call has been or is going to be established at the UE. At 402, a CU occurs for the 3G/4G call established or being established at the UE due to RLF or URE (or OOS), and may be caused by transmitter (TX) sharing or blanking, RF de-sense, etc. For example, as described, 3G/4G can use transmitter/receiver statistics (e.g., over past N slots) of “single TX sharing,” “TX blanking,” or “RF de-sense,” provided by common functional entities (between 2G and 3G/4G), such as a common PHY, media access control (MAC), RLC layer, etc. to determine a cause of RLF/URE/OOS. Accordingly, as described above, T314/T315 timer(s) (e.g., T314/T315 timer 122) can be initialized at 404 for determining when to enter idle mode, and a TPST timer (e.g., TPST timer 120) is initialized at 406 for throttling PS call establishment attempts. Cell reselection can be initiated at 407, and a CU spacing timer can be initialized at 408 (e.g., CU spacing 1 timer 124) to defer a first CU procedure. After expiration of the CU spacing timer, a CU procedure can be attempted. In this example, this initial CU procedure fails (e.g., a CU complete or CU confirm message is not received), and a different CU spacing timer can be initialized at 410 (e.g., CU spacing 2 timer 126), after expiration of which another CU procedure is attempted.

At 412, a PS registration attempt (NAS PS Reg), which may be received from one or more higher NAS layers, is buffered since the TPST timer initialized at 406 (and/or the T314/T315 timer initialized at 404) has not expired. Buffering the PS registration attempt in this regard may decrease usage of shared transmitter resources by the 3G/4G call to mitigate impact to the 2G call where the PS registration attempt may likely fail due to the conditions that caused the CU procedure, as described. In any case, the second CU also fails in this example, and another CU spacing timer is initialized at 414, after expiration of which and without a successful CU procedure a third CU update is attempted.

The UE can perform a number of unsuccessful CU procedures in a CELL_FACH state based on a N302 count. If the UE does not perform a successful CU procedure before expiration of the T314 or T315 timer, the UE enters idle mode at 414. Another cell reselection is attempted at 416 and succeeds, in this example. It is to be appreciated, however, that additional cell reselection procedures in idle mode may fail before the successful procedure at 416. In any case, at 418, a PS registration attempt (NAS PS Reg) may be allowed in idle mode to enhance PS experience at the UE, but PS call establishment may still be triggered until a PS registration attempt succeeds. The TPST timer can be stopped based on the successful NAS PS Reg at 418, and PS call establishment attempts are thus no longer throttled at 420. It is to be appreciated that upon expiration of the TPST timer, if no successful NAS PS Reg has occurred, the UE may attempt to establish a PS call or otherwise cease from throttling PS call establishment attempts.

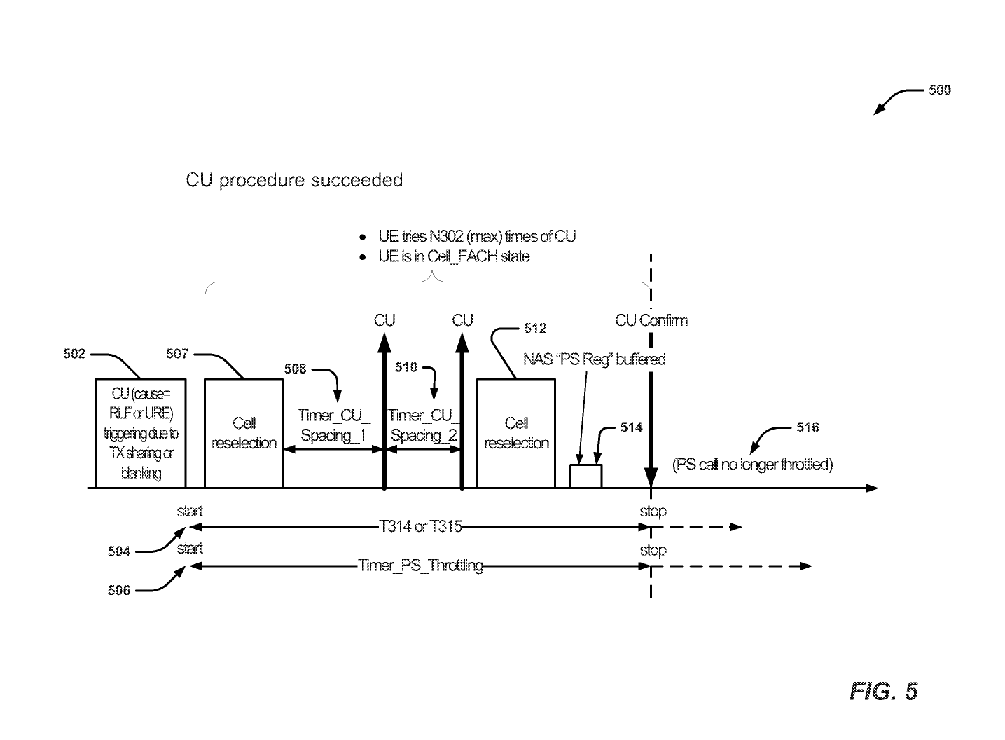

FIG. 5 depicts an example timeline 500 for wireless communications of a multi-subscription UE in accordance with aspects described herein. At the outset, it can be assumed that a CS call is on-going, though not shown, such as a second generation (2G) call, and a third generation (3G)/fourth generation (4G) call has been or is going to be established at the UE. At 502, a CU occurs for the 3G/4G call established or being established at the UE due to RLF or URE (or OOS), and may be caused by transmitter (TX) sharing or blanking, RF de-sense, etc. For example, as described, 3G/4G can use transmitter/receiver statistics (e.g., over past N slots) of “single TX sharing,” “TX blanking,” or “RF de-sense,” provided by common functional entities (between 2G and 3G/4G), such as a common PHY, media access control (MAC), RLC layer, etc. to determine a cause of RLF/URE/OOS. Accordingly, as described above, T314/T315 timer(s) (e.g., T314/T315 timer 122) can be initialized at 504 for determining when to enter idle mode, and a TPST timer (e.g., TPST timer 120) is initialized at 506 for throttling PS call establishment attempts. Cell reselection can be initiated at 507, and a CU spacing timer can be initialized at 508 (e.g., CU spacing 1 timer 124). After expiration of the CU spacing timer, a CU can be attempted. In this example, this initial CU procedure fails, and a different CU spacing timer can be initialized at 510 (e.g., CU spacing 2 timer 126), after expiration of which another CU procedure is attempted.

The second CU procedure can succeed in this example, and at 512, cell reselection is performed. In this example, the TPST timer can be maintained at least until a CU complete or CU confirm message is received at the UE, at which point the TPST timer may be stopped. Thus, at 514, a PS call establishment attempt (NAS PS Reg) may still be buffered since the TPST timer initialized at 506 is still running. Upon receiving the cell update confirm, however, the TPST timer and T314/T315 timers are stopped, and PS call establishment attempts are no longer throttled at 516 since a connection with a cell can be established for the PS call. Thus, a subsequent NAS PS Reg and/or a related PS call establishment attempt (not shown) may be allowed. In one example, cell update based on the one or more conditions (e.g., RLF/URE/OOS) and/or related causes may occur again according to the same timeline 500 during the same CS call, and the initial CU spacing timer 508 can be used for initial CU procedure in this subsequent RLF/URE/OOS, before using the different CU spacing timer 510 for possible additional CU procedure(s).

Several aspects of a telecommunications system have been presented with reference to a W-CDMA system. As those skilled in the art will readily appreciate, various aspects described herein may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects described herein, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented herein depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method for throttling packet-switched (PS) call establishment in wireless communications, comprising:
conducting a circuit-switched (CS) call using a first radio access technology (RAT);
detecting a cell update (CU) procedure for a PS call using a second RAT due to one or more conditions;
determining a cause for the one or more conditions based on one or more parameters related to a transmitter or receiver; and
throttling PS call establishment attempts based at least in part on determining the cause for the one or more conditions.

2. The method of claim 1, wherein the one or more conditions include at least one of radio link failure (RLF), unrecoverable radio link control (RLC) error (URE), or out-of-service (OOS).

3. The method of claim 2, wherein the cause for the RLF, URE, or OOS relates to single transmitter sharing, and the one or more parameters indicate a number of slots during which the transmitter transmits for the CS call compared to another number of slots during which the transmitter transmits for the PS call.

4. The method of claim 2, wherein the cause for the RLF, URE, or OOS relates to transmitter blanking, or radio frequency de-sense, and the one or more parameters indicate a number of slots during which the transmitter for transmitting for the PS call is blanked for receiving transmissions for the CS call.

5. The method of claim 1, wherein throttling PS call establishment attempts comprises at least one of initializing a PS throttling timer based at least in part on determining the cause for the one or more conditions, or determining whether the PS throttling timer is expired before attempting a PS call establishment.

6. The method of claim 5, further comprising stopping the PS throttling timer where a subsequent CU procedure succeeds to allow PS call establishment attempts.

7. The method of claim 1, wherein throttling PS call establishment attempts comprises initializing a first CU spacing timer after expiration of which a first CU procedure is performed, and initializing a second CU spacing timer after expiration of which a second CU procedure is performed where the first CU procedure fails.

8. The method of claim 7, further comprising transitioning to an idle mode where a CU procedure does not succeed before expiration of a timer for releasing radio resources, and allowing one or more non-access stratum (NAS) PS registration attempts while in the idle mode.

9. The method of claim 8, further comprising stopping the PS throttling timer where at least one of the one or more NAS PS registration attempts succeed.

10. The method of claim 7, further comprising adjusting at least one of the first CU spacing timer or the second CU spacing timer based at least in part on one or more parameters from one or more previous PS calls.

11. The method of claim 10, wherein the one or more parameters relate to at least one of quality and sustainability of the CS call or a determined impact of the cause for the one or more conditions in the one or more previous PS calls.

12. The method of claim 1, wherein throttling PS call establishment attempts comprising buffering one or more non-access stratum PS call establishment requests while the PS throttling timer is running.

13. An apparatus for throttling packet-switched (PS) call establishment in wireless communications, comprising:
a transceiver configured to conduct a circuit-switched (CS) call using a first radio access technology (RAT); and
one or more processors configured to execute:
a condition detecting function configured to detect a cell update (CU) procedure for a PS call using a second RAT due to one or more conditions, and determine a cause for the one or more conditions based on one or more parameters related to a transmitter or receiver; and
a PS call establishing function configured to throttle PS call establishment attempts based at least in part on determining the cause for the one or more conditions.

14. The apparatus of claim 13, wherein the one or more conditions include at least one of radio link failure (RLF), unrecoverable radio link control (RLC) error (URE), or out-of-service (OOS).

15. The apparatus of claim 14, wherein the cause for the RLF, URE, or OOS relates to single transmitter sharing, and the one or more parameters indicate a number of slots during which the transmitter transmits for the CS call compared to another number of slots during which the transmitter transmits for the PS call.

16. The apparatus of claim 14, wherein the cause for the RLF, URE, or OOS relates to transmitter blanking, or radio frequency de-sense, and the one or more parameters indicate a number of slots during which the transmitter for transmitting for the PS call is blanked for receiving transmissions for the CS call.

17. The apparatus of claim 13, wherein the PS call establishing function is configured to throttle PS call establishment attempts at least in part by initializing a PS throttling timer based at least in part on determining the cause for the one or more conditions, or determining whether the PS throttling timer is expired before attempting a PS call establishment.

18. The apparatus of claim 13, wherein the PS call establishing function is configured to throttle PS call establishment attempts at least in part by initializing a first CU spacing timer after expiration of which a first CU procedure is performed, and initializing a second CU spacing timer after expiration of which a second CU procedure is performed where the first CU procedure fails.

19. A computer-readable storage medium comprising computer-executable code for throttling packet-switched (PS) call establishment in wireless communications, the code comprising:
code for conducting a circuit-switched (CS) call using a first radio access technology (RAT);
code for detecting a cell update (CU) procedure for a PS call using a second RAT due to one or more conditions;
code for determining a cause for the one or more conditions based on one or more parameters related to a transmitter or receiver; and
code for throttling PS call establishment attempts based at least in part on determining the cause for the one or more conditions.

20. The computer-readable storage medium of claim 19, wherein the one or more conditions include at least one of radio link failure (RLF), unrecoverable radio link control (RLC) error (URE), or out-of-service (OOS).
